(19) United States
(12) Patent Application Publication
(10) Pub. No.: US 2017/0254106 A1
(43) Pub. Date: Sep. 7, 2017

(54) LIGHTING TOWER

(71) Applicant: Mark Bruinsma, Red Deer (CA)

(72) Inventor: Mark Bruinsma, Red Deer (CA)

(21) Appl. No.: 15/430,120

(22) Filed: Feb. 10, 2017

(30) Foreign Application Priority Data
Feb. 12, 2016 (CA) 2920675

(51) Int. Cl. E04H 12/18; B60Q 1/24; F21V 21/22; B60R 11/06

(52) U.S. Cl. CPC E04H 12/187; E04H 12/182; B60R 11/06; B60Q 1/24; F21V 21/22; F21Y 2115/10

(57) ABSTRACT

A lighting tower system comprises a tower having adjacent telescoping sections, the telescoping sections sliding relative to one another between retracted and extended positions, and the telescoping sections comprising at least an upper section and a lower section. A light assembly is rotatably mounted to the upper section such that the light assembly may be rotated from a first position parallel to the tower to a second position extending away from the tower. A storage container is positioned in the bed of a vehicle, and the tower is fitted in the storage container and connected to the storage container by a folding mechanism, the folding mechanism permitting the tower to move between a folded position inside the storage container and an upright position extending out of the storage container when the tower is retracted and the light assembly is in the first position.

### TECHNICAL FIELD

Lighting towers, and in particular, telescoping lighting towers.

### BACKGROUND

Mobile temporary lighting is used at locations where lighting is limited and additional lighting is needed. Temporary lighting for short periods of time may be required, and may need to be erected or removed quickly. For example, temporary lighting may be necessary for night shifts at work sites and in emergency situations. Often bulky trailers or skids are used to move and support temporary light towers.

### SUMMARY

In an embodiment, there is provided a lighting tower system comprising a tower comprising adjacent telescoping sections, the telescoping sections sliding relative to one another between retracted and extended positions, the telescoping sections comprising at least an upper section and a lower section; a light assembly rotatably mounted to the upper section such that the light assembly may be rotated from a first position parallel to the tower to a second position extending away from the tower; a storage container positioned in the bed of a vehicle, wherein the tower is fitted in the storage container and connected to the storage container by a folding mechanism, the folding mechanism permitting the tower to move between a folded position inside the storage container when the tower is retracted and the light assembly is in the first position and an upright position extending out of the storage container.

In an embodiment, there is provided a lighting tower system comprising an extendable tower mounted in a container in a vehicle, the tower comprising at least an upper section and a lower section; a light assembly extending from the upper section; the tower being rotatably mounted in the container by a folding mechanism for raising and lowering the tower into the container; and the light assembly being rotatably attached to the upper section such that the light assembly can be rotated between a first position aligned with the tower to a second position extending outwardly from the tower.

In various embodiments, there may be included any one or more of the following features: the folding mechanism comprises a rotational element; the folding mechanism further comprises a linear actuator; the linear actuator is electrically powered; the telescoping sections comprise tubes; the tubes are square in cross-section; the tubes are circular in cross-section; the telescoping sections are controlled by an electrically powered mechanism; the electrically powered mechanism is an electric winch system; the electric winch system comprises a plurality of cables and sheaves; the cables and sheaves are made of steel; the storage container is fixed to the vehicle; the vehicle is a pick-up truck; the light assembly is connected to the upper section by a hinge; the light assembly comprises an arm and a light fixture, the arm connected to the light fixture and rotationally connected to the upper section; the arm is rotationally connected to the light fixture; the light assembly comprises a first light fixture and a second light fixture, and the first light fixture and the second light fixture are each mounted to the arm.

The folding mechanism may include a pivot, the container may have a wall with a step and the pivot may be spaced from the step so that the lower section rests on the step when the tower is in the vertical position

### BRIEF DESCRIPTION OF THE FIGURES

Embodiments will now be described with reference to the figures, in which like reference characters denote like elements, by way of example, and in which:

FIG. 1 is a perspective view of an embodiment of a lighting tower system, mounted in a pick-up truck;

FIG. 2 is a front view of the embodiment of FIG. 1, in which the storage container is open and the tower is upright, and the truck is not shown;

FIG. 3 is a front view of the embodiment of FIG. 1, in which the storage container is closed and the tower is inside the storage container, and the truck is not shown;

FIG. 4 is a top view of the embodiment of FIG. 1, in which the tower is inside the storage container, and the truck is not shown;

FIG. 5 is a perspective view of the embodiment of FIG. 1, in which the tower is fully extended, and the truck is not shown.

### DETAILED DESCRIPTION

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

Referring to FIG. 1, an embodiment of a lighting tower system 10 is shown in a bed 12 of a vehicle 14, which in this example is a pickup truck. The lighting tower system 10 can be easily moved to provide temporary mobile lighting to vehicle-accessible locations to provide a safer and more secure worksite or emergency scene. For example, the lighting tower system 10 may be used in utility construction, road construction, oil and gas construction and maintenance, emergency response, farming, outdoor public events and towing and recovery services. Since the lighting tower system 10 is mounted in a vehicle 14, the lighting tower system 10 can be brought to difficult-to-access locations and the system 10 can be set up immediately upon arrival.

The lighting tower system 10 comprises a tower 16, a light assembly 18, a folding mechanism 20 and a storage container 22. The tower 16 comprises adjacent telescoping sections 24, and the tower 16 expands upwardly by the telescoping sections 24 sliding relative to one another, moving from a retracted position to an extended position.

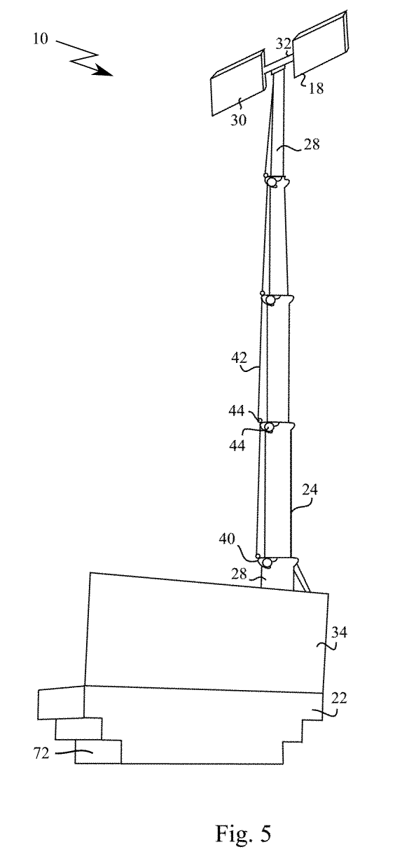

The telescoping sections 24 comprise at least an upper section 26 and a lower section 28. The light assembly 18 may comprise a light fixture 30 and an arm 32, the arm 32 connected to the upper section 26 at a first end and the arm 32 connected to the light fixture at a second end. The arm 32 may be rotatably mounted to the upper section 26 and to the light fixture 30. There may be multiple arms 32 extending from the upper section 26, such as, as shown, two arms. There may be more than two telescoping sections. Light assembly 18 may extend from any of the sections. The light assembly 18 may be rotated from a first position aligned with the tower 16 as shown for example in FIG. 1 to a second position extending outwardly or away from the tower 16 as shown in FIG. 5. The first position may be parallel to the tower 16 and the second position may extend away from the tower or be unobstructed by the tower 16.

The storage container 22 is positioned in the bed of the vehicle 14. The tower 16 may be fitted or mounted in the storage container 22, and the folding mechanism 20 connects the tower to the storage container, in order to support the tower 16 in an upright position and to raise and lower the tower 16. The folding mechanism 20 may be attached to part of the lower section 28. The folding mechanism 20 permits the tower 16 to move between a folded position inside the storage container 22 and an upright position extending out of the storage container 22, when the tower 16 is retracted and the light assembly 18 is parallel to the tower 16.

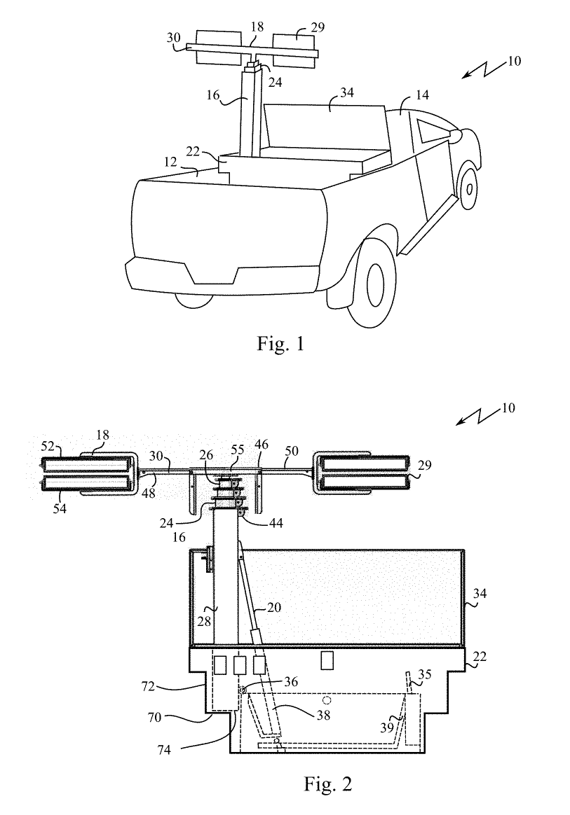

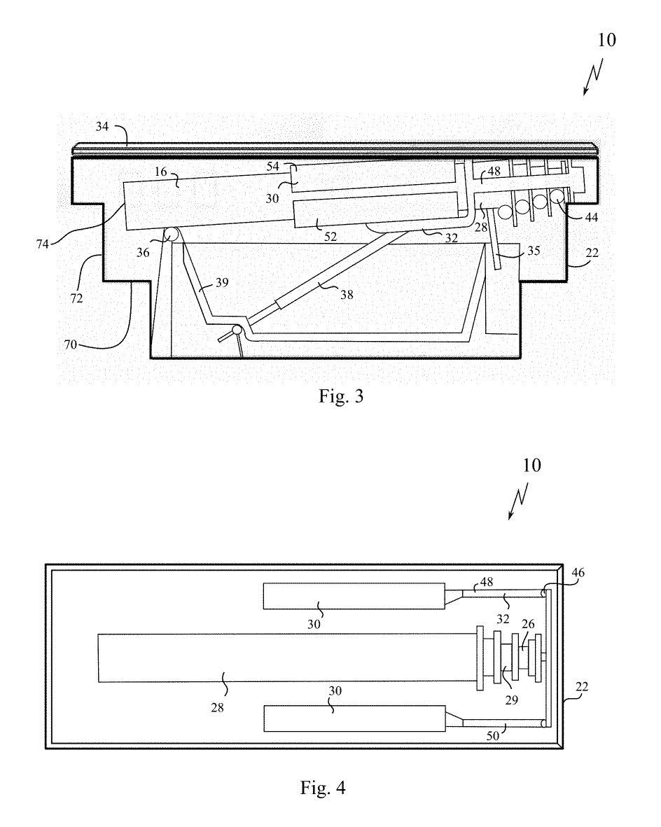

FIGS. 1 and 2 show the light assembly 18 in the second position and the tower 16 in the upright position, which is an open position of the light tower system 10. FIGS. 3 and 4 show the light assembly 18 in the first position and the tower in the folded position, which is a closed position of the lighting tower system 10. The tower 16 may be moved from a fully closed to a fully opened position. In a fully closed position, the tower 16 may be stored in the storage container 22 and a lid 34 may be closed over the storage container 22 to prevent damage to the lighting tower system 10. There may also be a support 35 for the tower 16 to rest on when in its fully lowered position. FIG. 5 shows the system 10 in a fully opened position.

The folding mechanism 20 may comprise a rotational element 36 such as a hinge or pivot and a linear actuator 38, which act together to rotate the tower 16 from a folded position to an upright position. The linear actuator 38 may be electrically powered, and may comprise an electronic limit switch to prevent rotation of the tower 16 beyond a certain angle. The folding mechanism 20 may further comprise a structure 39 inside the storage container 22 which supports the rotational element 36 and the linear actuator 38.

The telescoping sections 24 may be tubular, which may be for example square, circular, or any other simple convex polygonal shape, in cross-section. The telescoping sections 24 may for example be made of metal.

The telescoping sections 24 may be controlled by an electrically powered mechanism, which may for example be an electric winch system 40. The electric winch system 40 may comprise a plurality of cables 42 and sheaves 44. The cables 42 and sheaves 44 may be made of metal, such as for example steel. The electrically powered mechanism 40 may comprise an electronic limit switch to prevent the telescoping sections from extending further than desired.

The system 10 may be powered by any standard AC power supply. The system 10 may be powered by a battery bank, for example, and the battery bank may be housed in the storage container. The battery bank may be charged from AC shore power or the charging system of the vehicle 14. Shore power may include any standard 120V AC power source which may be converted to DC power and used to energize the light fixtures. An automatic charge relay, which may form part of the electrical system for the light tower, may be used to ensure that the vehicle's primary starting battery is never overdrawn, to avoid potentially leaving the vehicle 14 inoperable. Charging may occur any time the carrier vehicle 14 is running therefore storing any unused electrical energy created by the carrier vehicle 14. The battery bank power may pass through a pure sine wave inverter before entering the system, in order to convert the battery bank power from direct to alternating current.

The arm or arms 32 may be connected to the upper section 28 by a hinge or hinges 46. There may be a first arm 48 and a second arm 50, the first arm 48 rotatably mounted to the upper section 26 and the second arm 50 rotatably mounted to the upper section. Each arm 32 may have one or more light fixtures 30 attached to it. For example, a first light fixture 52 and a second light fixture 54 may be attached to the first arm 48. There may be more light fixtures 30 attached to each arm, each having any of a variety of sizes and styles. The arms 32 may also rotate on an axis parallel to the ground to allow the light fixtures 30 to be directed towards the ground at a variety of angles.

The system 10 may be operated by opening the lid 34 of the storage container 22, if any. A master power switch may be provided, which is turned on. The tower 16 may be raised from the first position to the second position using a control pendant. The light assembly 18 may be raised for example by unfolding arms 32 and rotating them around the axis of the tower, and angling the light fixtures 30 upwards or downwards, so that the light fixtures 30 face the area to be illuminated. This positioning can be done manually or mechanically. A hub 55 may be rotationally fixed to the upper section 26 of the tower 16 which may rotate around the axis of the tower 16. The hub 55 may be attached to the arms 32 so that the light assembly 18 may be rotated in any direction.

The light fixtures 30 may be turned on before raising the telescoping sections 24. The telescoping sections 24 may be extended to any desired height up to the full extension of the telescoping sections 24, for example by using the control pendant to initiate the telescoping winch system 40. The telescoping electric winch system 40 may automatically stop the extension when the tower 16 reaches its full height. A spring actuated mechanical lock may engage when full extension is reached.

The mechanical lock may be released prior to lowering the tower 16, and the tower 16 may be lowered by releasing the telescoping winch system 40, for example by using the control pendant. When the tower 16 is completely retracted, the light assembly 18 may be lowered to the first, stowable, position. The light assembly 18 may be locked in this position. The tower 16 may be lowered from a vertical position to a horizontal stowed position inside the storage container 22. The power may be turned off and the lid of the storage container 22 closed.

The lighting tower system 10 may, for example, be mounted in the bed 12 of a pick-up truck next to the cab while still allowing space in the bed for other purposes.

The light fixtures 30 may be low voltage LED lights, which may result in lower maintenance and emissions. LED lights also provide light immediately on being powered, and do not require warm up or cool down time. The LED lights do not produce noise pollution. The light fixtures 30 may be flood or area light fixtures.

The system 10 may be set up in a vehicle without major modifications to the vehicle's electrical systems or mechanical structure. The storage container 22 may be fixed to the vehicle 14 in order to provide stability to the system 10. The system 10 may be easily mounted and secured to the vehicle by a variety of standard methods, including bolts, cables or rods attached to a pickup truck bed.

The container 22 may have one or more steps 70 in one or more walls 72 of the container 22 and a bottom end 74 (lower part of the lower section) of the tower 16 may rest on a step 70 when the tower 16 is in a vertical position extending out of the container 22. The pivot or hinge about which the tower 16 rotates is spaced from the wall of the container and the step so that when the tower is vertically oriented, the lower section rests on the step.

What is claimed is:

1. A lighting tower system comprising:
a tower comprising adjacent telescoping sections, the telescoping sections sliding relative to one another between retracted and extended positions, the telescoping sections comprising at least an upper section and a lower section;
a light assembly rotatably mounted to the upper section such that the light assembly may be rotated from a first position parallel to the tower to a second position extending away from the tower; and
a storage container positioned in a bed of a vehicle,
wherein the tower is fitted in the storage container and connected to the storage container by a folding mechanism, the folding mechanism permitting the tower to move between a folded position inside the storage container when the tower is retracted and the light assembly is in the first position and an upright position extending out of the storage container.

2. The system of claim 1 wherein the folding mechanism comprises a rotational element.

3. The system of claim 1 wherein the folding mechanism further comprises a linear actuator.

4. The system of claim 3 wherein the linear actuator is electrically powered.

5. The system of claim 1 wherein the telescoping sections comprise tubes.

6. The system of claim 5 wherein the tubes are square in cross-section.

7. The system of claim 5 wherein the tubes are circular in cross-section.

8. The system of claim 1 wherein the telescoping sections are controlled by an electrically powered mechanism.

9. The system of claim 8 wherein the electrically powered mechanism is an electric winch system.

10. The system of claim 9 wherein the electric winch system comprises a plurality of cables and sheaves.

11. The system of claim 10 wherein the cables and sheaves are made of steel.

12. The system of claim 1 wherein the storage container is fixed to the vehicle.

13. The system of claim 1 wherein the vehicle is a pick-up truck.

14. The system of claim 1 wherein the light assembly is connected to the upper section by a hinge.

15. The system of claim 1 wherein the light assembly comprises an arm and a light fixture, the arm connected to the light fixture and rotationally connected to the upper section.

16. The system of claim 15 wherein the arm is rotationally connected to the light fixture.

17. The system of claim 15 wherein the light assembly comprises a first light fixture and a second light fixture, and the first light fixture and the second light fixture are each mounted to the arm.

18. The system of claim 1 in which the folding mechanism includes a pivot, the container has a wall with a step and the pivot is spaced from the step so that the lower section rests on the step when the tower is in the vertical position.

19. A lighting tower system comprising:
an extendable tower mounted in a container in a vehicle, the tower comprising at least an upper section and a lower section;
a light assembly extending from the upper section;
the tower being rotatably mounted in the container by a folding mechanism for raising and lowering the tower into the container; and
the light assembly being rotatably attached to the upper section such that the light assembly can be rotated between a first position aligned with the tower to a second position extending outwardly from the tower.

20. A lighting tower system comprising:
a tower having a lower section, an upper section, a telescoping part and a pivoting part;
the tower being pivotally mounted by the pivoting part in a container of a vehicle, the container having a step in a wall of the container;
a light assembly mounted to the upper section; and
the pivoting part being spaced from the wall of the container and the step so that when the tower is vertically oriented, the lower section rests on the step.
